(19) United States
(12) Patent Application Publication
(10) Pub. No.: US 2022/0330563 A1
(43) Pub. Date: Oct. 20, 2022

(54) PRESERVATIVE-FREE FREEZED-DRIED FOODS AND METHODS OF MAKING THE SAME

(71) Applicant: Eric Campbell, Springville, CA (US)

(72) Inventor: Eric Campbell, Springville, CA (US)

(21) Appl. No.: 17/684,440

(22) Filed: Mar. 2, 2022

Related U.S. Application Data
(63) Continuation of application No. 17/529,263, filed on Nov. 18, 2021, now abandoned.
Application No. 17/529,263 is a continuation of application No. 17/233,267, filed on Apr. 16, 2021, now abandoned.

(51) Int. Cl. A23B 7/024; A23B 7/022; A21D 15/02; A23L 19/00; A23P 30/10; A23B 7/005; A21D 15/04

(52) U.S. Cl. CPC A23B 7/024; A23B 7/022; A21D 15/02; A23L 19/09; A23P 30/10; A23B 7/005; A21D 15/04; A23V 2002/00

(57) ABSTRACT

The present invention relates to novel freeze-dried confection compositions, and methods for making the same. There is a long-felt need for nutritious snacks that are preserved for long periods without preservatives and having acceptable flavor. The freeze-dried confections of the present invention comprise are composed of freeze-dried raw fruits and vegetables and other natural ingredients with no preservatives, and prepared in such a way that they can be preserved at room temperature for many years.

### FIELD OF THE INVENTION

The present invention relates to dehydrated or freeze-dried confections obtained from natural ingredients. In the following description the freeze-dried confections composed of natural ingredients without preservatives that are able to be stored for years without refrigeration or other treatment.

### DISCUSSION OF THE BACKGROUND

Freeze drying is a low temperature dehydration process that involves freezing the product, lowering pressure, then removing the water by sublimation (ice to vapor). This is in contrast to dehydration by most conventional methods that evaporate water using heat. Freeze drying is typically used in research and industrial contexts to preserve biological materials (e.g., bacteria and yeasts), biomedical materials, pharmaceuticals (e.g., penicillin), dry commodity processing (e.g., coffee), and for military and NASA rations (e.g., processed food powders to be rehydrated in a tube or other container).

Prior applications of freeze-drying have been aimed at situations that require preservation, such as NASA missions and the delivery of Penicillin to the battlefield during military operations. Freeze-drying has found limited application in other areas of food preparation, mainly being used to preserve commodity items (e.g., yeast, bouillon cubes, etc.). New applications of the process have not advanced in some time. Therefore, new and innovative applications have of freeze-drying are lacking.

### SUMMARY OF THE INVENTION

The present invention provides novel freeze-dried confection compositions, and methods for making the same. There is a long-felt need for nutritious snacks that are preserved for long periods without preservatives and having acceptable flavor. The freeze-dried confections of the present invention comprise are composed of freeze-dried raw fruits and vegetables and other natural dairy and dessert ingredients with no preservatives, and prepared in such a way that they can be preserved at room temperature for many years. The fruit or vegetable compositions used in the preparation of the freeze-dried confection product may be pureed and may be present in amount of from about 50% wt/wt to about 100% wt/wt of the composition.

The freeze-dried food product (e.g., a confection) obtained from a starting material containing fresh fruit and/or vegetable content, or other dairy and dessert food material. The sweetness and flavor of the freeze-dried composition may be provided by the fresh fruit and/or vegetables. In other embodiments, ice creams and baked goods (e.g., pies) made with natural ingredients without added preservative chemicals. Raw food materials contain a lot of water, ranging from about 80% to about 95% wt/wt. In other embodiments, ice creams, other dairy products, and baked goods (e.g., dessert goods, such as pies) made with natural ingredients without added preservative chemicals. Such foods may include water in an amount of about 60% to about 85%. The removal of water by sublimation during the freeze-drying process results in the creation of highly porous structure of the freeze-dried products. The water in the fresh fruits, vegetables and other foods may include free water or water bound to a matrix of molecules (e.g., carbohydrates, proteins, etc.) by intermolecular forces. Free water freezes, but bound water may not. In the freeze-drying process, all ice water may be removed. A majority of the bound water (e.g., about 50% wt/wt to about 99% wt/wt) may be removed as well.

A method of preparing a freeze-dried product according to the present invention may comprise the steps of (a) providing a puree or other mixture of fresh fruit, fresh vegetable, and/or other foods, (b) optionally adding one or more plant extracts and/or an emulsifier, (c) displacing oxidizing gases from the mixture, (d) thermally processing (e.g., freezing) the fruit or vegetable blend, (e) a primary freeze-drying process, and (f) a secondary freeze-drying process. This process removes water, liquids, and oxidants from the from the freeze-dried food that eliminates chemical, biochemical, and microbiological processes that would otherwise breakdown and spoil the food. The freeze-drying process allows for preservation of the novel snack foods without preservatives.

The freeze-drying process may include three major phases: a freezing phase, a primary drying phase, and a secondary drying phase. During the freezing phase the food product may exposed to temperatures in the range of about −50° C. to about −10° C. (e.g., about −30° C.) in order to convert into ice most of the water and/or solvents contained in the composition. In the primary drying phase the shelf temperature may be increased up to about 10° C. to about 20° C. while the pressure inside the drying chamber may be lowered to below about 0.001 atm to about 0.01 atm facilitating the sublimation of the frozen water and/or other liquids and solvents in the frozen composition directly from solid phase to gas phase. The application of high vacuum makes possible the water sublimation at low temperatures. Since freeze-drying is a low temperature process in which the temperature of product does not exceed typically 20° C. during the three phases, it causes less damage or degradation to the product than other dehydration processes using higher temperatures. The freeze-drying method of the present invention does not result in shrinkage or toughening of the product being dried. The freeze-dried products can be rehydrated much more quickly and easily because the porous structure created during the sublimation of vapor.

The freeze-drying method of the present invention removes the liquid water from food product to prevent chemical and biological activity that would otherwise result in degradation of the food material. Water acts as a reaction medium and affects the rheological properties of the product. The presence of liquid water during the freeze-drying of a food product may result in many changes in the composition, morphology, and physical properties of foods (e.g., shrinkage, color change, etc.). Thus, freezing is a critical stage during freeze-drying process. Fresh food products such as fruits and vegetables may be frozen before freeze-drying, which crystallizes water and other fluids in the food material. Freezing the water in the food material immobilizes the ingredients in solution and prevents foaming during pressure reduction, limits the chemical, biochemical, and microbiological reactions and activity in the material, creates a crystalline ice structure in the frozen product, which facilitates the migration of water vapor from the dried material, and stiffens the structure.

The rate at which a material is frozen is dependent on the type of material. Higher water content of pureed fruits and vegetables correlates with a higher freezing rate. Fruits and vegetable purees may have a moisture content in a rang of about 80% wt/wt to about 95% wt/wt. Such materials may be best frozen at a relative low temperature in order to yield a higher number of small ice crystals, which facilitates sublimation of the ice during the drying process. The freezing temperature for such fruit and vegetable purees may be in the range of about −50° C. to about −10° C. (or any value or range of values therein). Other food products may also be advantageously frozen in this temperature range, though the crystal structure of the ice may differ due to the difference in food material. A conventional freezer may be used. A blast freezer will result in a faster freezing rate and may thus improve the crystallization of the water in the puree.

Once freezing has completed, a first, primary freeze-drying may be performed, in which the ice sublimation process occurs. The heat is transferred from a shelf or radiant heat source to the surface of the frozen composition, thereby heating the frozen water therein. There may be an interface between frozen portion and dried portion of the food product that forms during the freeze-drying process. The dry region-ice interface may move inwards into the product, from the outer surface to the inner material, as the primary freeze-drying phase proceeds. The sublimation of frozen water and/or other liquids creates dried regions with porous structure, comprising a network of pores and gaps for the vapor escape. The external dried portion of the composition acts as insulator for the inner frozen portion and also as a variable resistance for vapor to escape, thus the drying process may require fluctuated amounts of heat over the course of the freeze-drying process to achieve sublimation throughout the food product. The temperature in the freeze-drying chamber may be fluctuated during the primary freeze-drying phase in a range of about 0° C. up to about 20° C.

The pressure, vapor pressure, and applied heat parameters during the freeze-drying process are pre-determined to accomplish successful freeze-drying. The supplied heat may be fluctuated depending on the heating method: for contact heating using a heating shelf arrangement, the shelf temperature determines heat transfer. The temperature of the condenser surface should be from about −10° C. to about −50° C., depending on the type of freeze-dried material. The pre-determined pressure in the chamber and the condenser temperature also factor into the freeze-drying process. The pressure within the chamber may be in a range of about 0.001 atm to about 0.01 atm. During sublimation, the amount of heat required for the sublimation of the ice layer correlates to the ice crystal size. The larger the ice crystals, the larger the heat transfer resistance. Thus, the smaller ice crystals facilitate a faster rate of sublimation and freeze-drying. Sublimed steam must be removed from the freeze-drying chamber by applied vacuum. The vapor extracted from the food product may be removed from the drying chamber by means of condenser plates or coils of the condenser where the vapor can be re-solidified or frozen.

In some embodiments, the process may include a second drying phase (a post-drying step) may be conducted under a reduced pressure. This step may be performed to remove the water present in the freeze-dried material that did not form ice during the freezing process, and instead is bound to the solid material (matrix) of the freeze-dried substance. During the second drying phase, absorbed water (the water attached to the dry material that did not freeze) may be desorbed by several mechanisms, including evaporation and desorption of the formed steam from the solid matrix, convective transport through pores in the material, gas diffusion of the steam, and diffusion of water out of the matrix and dry material. During the secondary drying phase the shelf temperature may be further increased up to a maximum of about 20° C. to about 40° C. to heat the product, while the pressure inside the drying chamber is lowered to about 0.0001 atm to about 0.001 atm. At the end of secondary drying phase, the product may be sufficiently dried with residual moisture content typically of about 1% to about 3% wt/wt.

The freeze-drying apparatus utilized for performing a freeze-drying process of the present invention may include a drying chamber and a condenser chamber interconnected by a duct that is provided with a valve that allows isolating the drying chamber when required during the process. The drying chamber may comprise a plurality of temperature-controlled shelves and/or radiant heat sources arranged for receiving containers of the composition to be dried. The condenser chamber may include one or more condenser plates or coils having surfaces maintained at very low temperature, e.g., —50° C., by means of a refrigerant or freezing device. The condenser chamber and the drying chamber may also be connected to one or more vacuum pumps evacuating air so as to achieve high vacuum value inside both chambers.

The food product produced by the freeze-drying method of the present invention may be a nutritious, small volume (e.g., bite size) confection that may have a shelf life of about 25 years due to the remove of nearly all moisture therein, thereby eliminating biological activity and reducing chemical processes to a negligible level.

The freeze-dried product can be sealed in containers to prevent the reabsorption of moisture. In this way the product may be stored at room temperature without refrigeration, and be protected against spoilage for many years. The fruit and/or vegetable, and in some instances dairy or dessert ingredients, blend may be a puree of one or more types of fresh fruits and vegetables. The puree may be of whole fruit and vegetables containing all tissues and nutrition in the fresh fruits and vegetables. The puree allows the food product to be molded into pre-determined shapes. The puree may be molded into a geometric body of a regular shape, for example, in particular, spherical caps, spheroidal caps, rectangular prisms, pyramids, as well as irregular shapes and whimsical shapes, such as those in the form of animals, plants and parts of plants, such as leaves etc. Spheroidal shapes are particularly advantageous for the sublimation process, as the distance from the surface to the interior is uniform from the exterior surface to the center of the shape, which facilitates vapor transport through the already dry material during the freeze-drying process.

A plurality of the molded, freeze-dried food products may be included in a container, which may have a mixture of molded food products with different geometries and/or different sizes. The molded food products may be packaged as a plurality of the molded food products. The freeze-dried food product may be produced with varying individual volumes. The volumes may be about four cubic inches or less. For example, the volume may be in a range of about 0.05 cubic inches to about 2 cubic inches. In a further example, the volume may be in a range of about 0.1 cubic inches to about 1 cubic inches.

The food composition may be treated with a non-oxidizing gas prior to the freezing stage in order to displace the air, and particularly the gaseous oxygen therein to prevent oxidation of the food product. This step may be performed in pressure chamber the puree may be placed in the pressure chamber nitrogen gas may be pumped into the pressurized chamber, thereby displacing the air (including O₂). The displaced air may be released from the pressurized chamber via a valve. A sufficient amount of N₂ gas may be pumped into the chamber to infuse the puree and displace substantially all of the air in the puree (e.g., in a range of about 80% to about 99% of the air volume present in the puree). In some embodiments, the N₂ gas may be pumped into the blender used to create the puree. The blender chamber may include a hose attachment for passing N₂ gas pumped from a reservoir. The blender chamber may also include a one-way valve to allow the air to be vented from the blender chamber.

In some embodiments, the food product composition may further comprise one or more plant extracts with medicinal and/or nutritional benefits. The one or more plant extracts may provide nutritional, analgesic, and/or medicinal benefits when ingested. One or more ingestible plant extracts may include various plant extracts, including citrus oils (e.g., lemon, orange, grape fruit, etc.), sesame oil, cinnamon oil, clove oil, geranium oil, lemongrass oil, mint oil, spearmint oil, wintergreen oil, rosemary oil, anise oil, fennel oil, ginger oil, chamomile oil, coriander oil, cumin oil, dill oil, parsley oil, basil oil, eucalyptus oil, jasmine oil, yarrow oil, ginger oil, bergamot oil, oregano oil, lavender oil, pepper oil, rose oil, tea tree oil, tea seed oil, turmeric oil, thyme oil, garlic oil, peppermint oil, onion oil, and cannabidiol oil, and others plant extracts having analgesic, medicinal and/or nutritional properties. For example, peppermint oil, lavender oil, eucalyptus oil, chamomile oil, rosemary oil, yarrow oil, ginger oil, clove oil, and cannabinoid oils have analgesic effects, and one or more of these plant extracts can be included in the puree to provide an additional benefit when ingested. Several of the plant extracts listed above also provide nutrients and vitamins that may enhance the food product of the present invention, such as citrus oils, clove oil, geranium oil, lemongrass oil, mint oil, spearmint oil, wintergreen oil, rosemary oil, anise oil, fennel oil, ginger oil, cumin oil, dill oil, parsley oil, basil oil, yarrow oil, ginger oil, oregano oil, lavender oil, and others. The one or more plant extracts may be present in an amount of from about 0.001% wt/wt to about 20% wt/wt, preferably from about 0.01% wt/wt to about 10% wt/wt of the food product composition.

The one or more plant extracts may be obtained from plant material by various methods, including infusion, percolation, ultra-sound assisted extraction, or other methods. Infusion may include grinding the plant material into a fine powder, mixing the ground material with an extraction solvent (e.g., an edible oil, such as olive oil or other ingestible hydrophobic compound operable to extract lipid materials) and allowing for the solvent to extract the hydrophobic compounds from the ground material for a pre-determined period (e.g., about 1 hour to about 24 hours), and filtering and collecting the extraction solvent. The wt/wt solvent to ground material ratio may be in a range of about 1:1 range to about 5:1. Heat may be applied during the extraction period. Percolation may utilize a percolator for the extraction process (e.g., a narrow-cone-shaped glass vessel with opening at both ends). Ground plant material may be moistened with the extraction solvent and allowed to sit for a pre-determined period (e.g., about 1 hour to about 6 hours). Subsequently, the mixture may be transferred into a percolator with the lower end thereof closed. The mixture may be allowed to stand in the percolator for a second pre-determined period (e.g., about 6 hours to about 24 hours). Additional extract solvent may then be poured from the top of the percolator until the ground plant material is saturated. The lower part of the percolator may then be opened, and additional solvent may be added to the top of the percolator, allowing solvent to drip slowly from the percolator by gravity. The solvent percolates through the ground material, collecting the hydrophobic materials in the ground plant material. The extract may be separated by filtration followed by decantation. Ultrasound-assisted extraction may involve the application of sound energy at a very high frequency (e.g., greater than 20 kHz) to disrupt plant cell walls in the ground plant material and increase the solvent penetration into the ground plant material. The ground plant material may be mixed with extraction solvent and packed into the ultrasonic extractor. The applied high frequency energy accelerates the extraction process, eliminates or reduces the need for the application of heat, and maximizes the yield of hydrophobic compounds from the plant material. Other methods of extracting oily compounds from plants may be alternatively or additionally utilized.

In some embodiments, the food product composition may further comprise one or more emulsifiers. While not wishing to be bound by any theories, it is believed that the one or more emulsifiers reduces the surface tension at the air-liquid interface, therefore allowing for stable dispersion of non-oxidizing gas and the one or more plant extracts within the viscous liquid matrix. Thus, the emulsifier aids in the infusion of N₂ gas into and the displacement of air into the puree, as the gas is able to more readily cross the penetrate or escape the puree due to the reduced surface tension. The emulsifier also aids in the miscibility and even dispersion of hydrophobic compounds in the one or more plant extracts throughout the puree. The one or more emulsifiers may include lecithin, mono- and diglycerides fatty acids and their esters with acetic, citric, lactic, and mono- and diacetyl tartaric or tartaric acids, distilled monoglycerides, polyglycerol fatty acid esters; polyoxyethylene sorbitan fatty acid esters (polysorbates); propylene glycol fatty acid esters; sorbitan fatty acid esters; stearoyl-2-lactylate salts; sugar esters; ammonium phosphatide, fatty acid salts, glycerol esters of wood resin, quillaia extract, and thermally oxidized soybean oil interacted with mono- and diglycerides of fatty acids are other approved emulsifiers. The one or more emulsifiers may be present in an amount of from about 0.001% wt/wt to about 1% wt/wt, preferably from about 0.01% wt/wt to about 0.5% wt/wt, of the composition. It is believed that the emulsifier component may promote stabilization of the final food product composition.

In some embodiments, the freeze-dried material may be further processed by breaking up the freeze-dried material, powderizing the material, and forming the resulting power into a pre-determined shape. In such embodiments, the powderization and compression may provide uniform texture and/or to allow for quick dissolution of the freeze-dried food product when ingested. In such embodiments, the freeze-dried food product can be powderized using a grinder or mill (to break down the food product into a fine powder. In some embodiments, this may be performed in a low-oxygen environment, under N₂ gas to prevent the additional of oxygen species into the freeze-dried material. The powderized food product may have a particle diameter of about 50 μm to about 250 μm (e.g., about 100 μm to about 200 μm, or any range or value therein).

The powderized food product may then be placed into a mechanical press to form compact snack/candy of uniform size and density to allow for the product to be easily packaged into various packaging types, including small pouches, candy trays and tins, plastic tubes, candy and roll packaging. The press may form a snack/candy of a predetermined size by pressing action of two punches and a die. In a first step, a bottom punch may be lowered in the die creating a cavity into which the powderized food product is fed. The depth of the lower punch may be set to apply a pre-determined size and volume of the shapes. An upper punch may be brought into contact with the powder and compress the powderized food product to fuse the powderized food product together into a hard snack/candy. After compression, the lower punch may be raised to remove the snack/candy. The pressing process may provide a consistent confection product.

It is a further objective of the present invention to provide improved freeze-dried confections and methods for producing such confections. Exemplary embodiments and implementations are provided below.

In one aspect, the present invention relates to a method of providing a preserved food product with no added preservative chemicals comprising the steps of providing a pureed food ingredient free from preservative chemicals; admixing a non-oxidizing gas with the pureed food ingredient; thermally processing the pureed food ingredient; and freeze drying the food ingredient. The food ingredient may be present in an amount of greater than 95% wt/wt of the product. The food product may comprise at least one fresh fruit or vegetable. The food product may include a baked food mixture free from preservative chemicals. The non-oxidizing gas may comprise of nitrogen gas. The pureed food ingredient may be shaped into a pre-determined shape. The pureed food ingredient may be poured in to a mold prior to the step of thermally processing the blend. The pre-determined shape may have a volume of less than about five cubic inches. The method may further include mixing an emulsifier into said pureed food ingredient. The emulsifier may be added into said pureed food ingredient at a concentration of 0.001% wt/wt to about 1% wt/wt of the pureed food ingredient. The method may include displacing air from said pureed food ingredient. The method may further include displacing O₂ from said pureed food ingredient. The method may further include pouring said pureed food ingredient into a mold having a volume of less than about 4 cubic inches. The method may further include pulverizing the freeze-dried pureed food ingredient. The method may further include placing said freeze-dried food ingredient into a mold having a volume of less than about 1 cubic inch.

In a second aspect, the present invention relates to a shelf stable molded freeze-dried food product comprising at least 90% wt/wt fresh fruit or vegetable ingredient that is free from preservative chemicals and that comprises is substantially water-free and oxygen-free. The food ingredient may be present in an amount of greater than 95% wt/wt of the product. The product may include a non-oxidizing gas. The non-oxidizing gas may be nitrogen gas. The pureed food ingredient may be shaped into a pre-determined shape. The pureed food ingredient may be pureed and poured in to a mold to form said pre-determined shape. The pre-determined shape may have a volume of less than about five cubic inches. The product may include an emulsifier. The may be emulsifier present in a concentration of 0.001% wt/wt to about 1% wt/wt of the freeze-dried product. The pre-determined shape may be formed by pulverizing a freeze-dried food ingredient into a fine powder, and placed in a press. The pre-determined shape may have a volume of less than about 1 cubic inch.

In a third aspect, the present invention relates to a shelf stable freeze-dried food product comprising a food product free from preservative chemicals and that comprises is substantially water-free and oxygen-free. The food ingredient may be present in an amount of greater than 95% wt/wt of the product. The food ingredient may include at least one fresh fruit or vegetable. The food ingredient may consist of at least one type of fresh fruit or vegetable. The food ingredient includes a baked food mixture free from preservative chemicals. The product may include a non-oxidizing gas. The non-oxidizing gas is nitrogen gas. The pureed food ingredient may be shaped into a pre-determined shape. The fresh fruit may be pureed food ingredient is pureed and poured in to a mold to form said pre-determined shape. The pre-determined shape may have a volume of less than about five cubic inches. The product may include an emulsifier. The emulsifier may be present in a concentration of 0.001% wt/wt to about 1% wt/wt of the freeze-dried product. The product may include a plant extract. The plant extract may be present in a concentration of 0.001% wt/wt to about 5% wt/wt of the freeze-dried product. The pre-determined shape may be formed by pulverizing a freeze-dried food ingredient into a fine powder, and placed in a press. The pre-determined shape may have a volume of less than about 1 cubic inch.

In a fourth aspect, the present invention relates to a freeze-dried product comprising a blend selected from the group consisting of fruit, vegetable, dairy, protein, grain and combinations thereof in an amount of greater than about 95% of the freeze-dried product, said freeze-dried product being substantially free from water and oxygen gas. The blend may be present in an amount of greater than 95% wt/wt of the product. The food ingredient may include at least one fresh fruit or vegetable. The food ingredient may consist of at least one type of fresh fruit or vegetable. The food ingredient may include a baked food mixture free from preservative chemicals. The product may include a non-oxidizing gas. The non-oxidizing gas may be nitrogen gas. The pureed food ingredient may be shaped into a pre-determined shape. The fresh fruit may be pureed food ingredient is pureed and poured in to a mold to form said pre-determined shape. The pre-determined shape may have a volume of less than about five cubic inches. The product may include an emulsifier. The emulsifier may be present in a concentration of 0.001% wt/wt to about 1% wt/wt of the freeze-dried product. The product may include a plant extract. The plant extract may be present in a concentration of 0.001% wt/wt to about 5% wt/wt of the freeze-dried product. The pre-determined shape is formed by pulverizing a freeze-dried food ingredient into a fine powder, and placed in a press. The pre-determined shape may have a volume of less than about 1 cubic inch.

In a fifth aspect, the present invention relates to a method of providing a preserved food product with no added preservative chemicals comprising the steps of creating a blended food product comprising greater than 95% wt/wt of a pureed food ingredient free from preservative chemicals; admixing a non-oxidizing gas with the pureed food ingredient to displace O₂ from the blended food product; placing the blended food product in a mold having a pre-determined shape; thermally processing the pureed food ingredient; and freeze drying the food ingredient. The pureed food product may include at least one fresh fruit or vegetable. The pureed food product may include a baked food mixture free from preservative chemicals. The non-oxidizing gas may comprise nitrogen gas. The pre-determined shape may have a volume of less than about five cubic inches. The method may include mixing an emulsifier into said pureed food ingredient. The emulsifier is added into said pureed food ingredient at a concentration of 0.001% wt/wt to about 1% wt/wt of the pureed food ingredient. The product may include a plant extract. The plant extract may be present in a concentration of 0.001% wt/wt to about 5% wt/wt of the freeze-dried product. The method may include pulverizing the freeze-dried pureed food ingredient. The method may include pouring said freeze-dried food ingredient into a mold having a volume of less than about 1 cubic inch.

Additional aspects and objects of the invention will be apparent from the detailed descriptions and the claims herein.

### BRIEF DESCRIPTION OF THE DRAWINGS

FIG. 1A shows a flow chart of a process for processing a food starting material into a freeze-dried product according to a method of the present invention.

FIG. 1B shows a flow chart of a process for processing a freeze-dried food product to yield a compress snack or candy according to a method of the present invention.

FIG. 2 shows an freeze-drying apparatus according to an embodiment of the present invention.

### DETAILED DESCRIPTION OF THE EXEMPLARY EMBODIMENTS

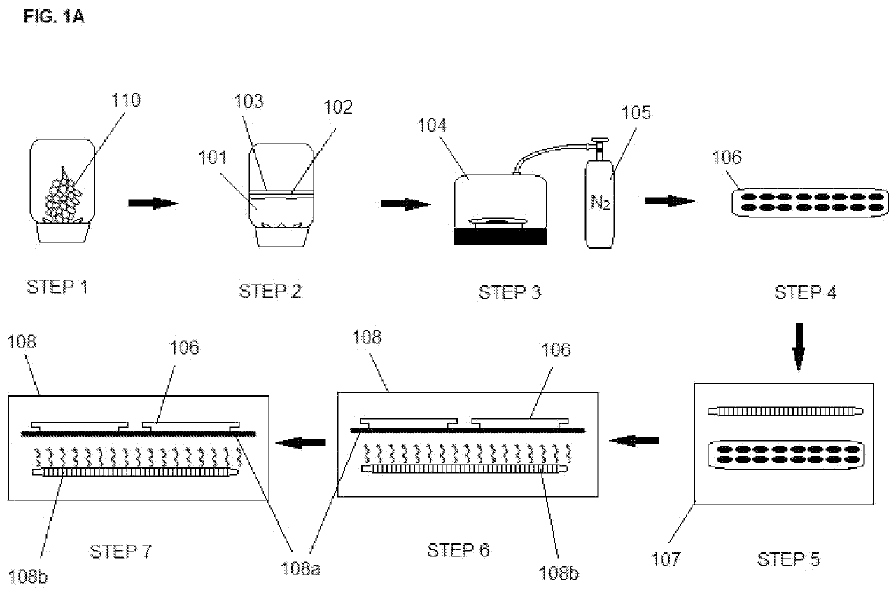

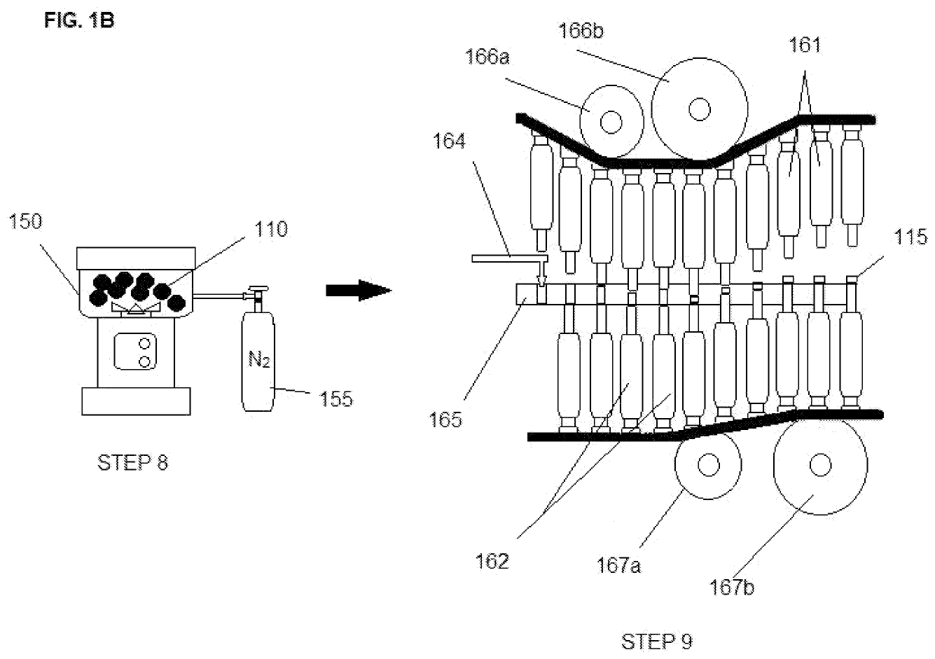

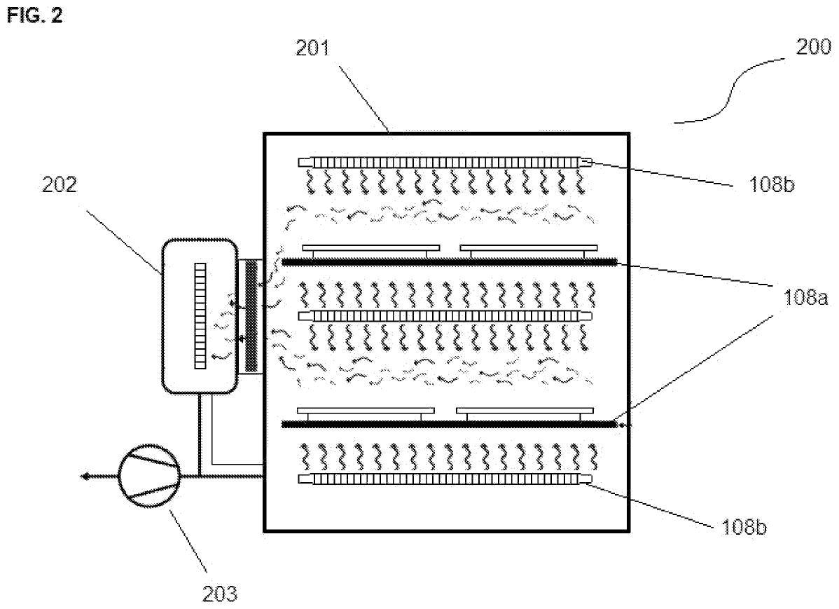

Reference will now be made in detail to certain embodiments of the invention, examples of which are illustrated in the accompanying drawings. While the invention will be described in reference to these embodiments, it will be understood that they are not intended to limit the invention. Conversely, the invention is intended to cover alternatives, modifications, and equivalents that are included within the scope of the invention as defined by the claims. In the following disclosure, specific details are given as a way to provide a thorough understanding of the invention. However, it will be apparent to one skilled in the art that the present invention may be practiced without these specific details. Referring to the drawings, wherein like reference characters designate like or corresponding parts throughout the several views, and referring particularly to FIGS. 1-2, it is seen that the present invention includes various embodiments of freeze-dried food products and methods of making the same.

As shown in FIG. 1, the present invention includes a method of preparing a freeze-dried product that may comprise the steps of (1) providing a puree or other mixture of fresh fruit, fresh vegetable, and/or other foods, (2) adding a plant extract and/or an emulsifier and blending the mixture (3) admixing a non-oxidizing gas with the blend to reduce the density of the composition and displace O₂ and other air components, (4) applying a pre-determined shape to food product prior to thermally processing the mixture, (5) thermally processing (e.g., freezing) the mixture, (6) applying a primary freeze-drying process, and (7) applying a secondary freeze-drying process. This process removes water, liquids, and oxidants from the from the freeze-dried food that eliminates chemical, biochemical, and microbiological processes that would otherwise breakdown and spoil the food. The freeze-drying process allows for preservation of the novel snack foods without preservatives.

A starting material 101 containing fresh fruit and/or vegetable content, or other food material (e.g., ice creams and baked goods) with no added preservative chemicals may be used for composing the freeze-dried food product. The starting material may be blended or pureed in an electric blender to provide a uniform consistency to the starting material. In step 2, the starting material may be mixed with one or more natural plant extracts 102 free from added preservative chemicals. The one or more plant extracts may be ingestible and may have medicinal and/or nutritional value when ingested. The plant extracts may include one or more of citrus extracts (e.g., lemon oil, orange oil, grape fruit oil, etc.), sesame oil, cinnamon oil, clove oil, geranium oil, lemongrass oil, mint oil, spearmint oil, wintergreen oil, rosemary oil, anise oil, fennel oil, ginger oil, chamomile oil, coriander oil, cumin oil, dill oil, parsley oil, basil oil, eucalyptus oil, jasmine oil, yarrow oil, ginger oil, bergamot oil, oregano oil, lavender oil, pepper oil, rose oil, tea tree oil, tea seed oil, turmeric oil, thyme oil, garlic oil, peppermint oil, onion oil, and cannabidiol oil, and others plant extracts having analgesic, medicinal and/or nutritional properties. The one or more plant extracts may be present in an amount of from about 0.001% wt/wt to about 20% wt/wt, preferably from about 0.01% wt/wt to about 10% wt/wt, of the food product composition.

Step 2 may also include the addition of one or more emulsifiers 103 to the mixture, which may reduce the surface tension at the air-liquid interface, therefore allowing for stable dispersion of non-oxidizing gas and the one or more plant extracts within the viscous liquid matrix of the pureed starting material. Thus, the emulsifier aids in the infusion of non-oxidizing gas into and the displacement of air into the puree, as the gas is able to more readily cross the penetrate or escape the puree due to the reduced surface tension. The emulsifier also aids in the miscibility and even dispersion of hydrophobic compounds in the one or more plant extracts throughout the puree. The one or more emulsifiers 103 may include lecithin, mono- and diglycerides fatty acids and their esters with acetic, citric, lactic, and mono- and diacetyl tartaric or tartaric acids, distilled monoglycerides, polyglycerol fatty acid esters; polyoxyethylene sorbitan fatty acid esters (polysorbates); propylene glycol fatty acid esters; sorbitan fatty acid esters; stearoyl-2-lactylate salts; sugar esters; ammonium phosphatide, fatty acid salts, glycerol esters of wood resin, quillaia extract, and thermally oxidized soybean oil interacted with mono- and diglycerides of fatty acids are other approved emulsifiers. The one or more emulsifiers 103 may be present in an amount of from about 0.001% wt/wt to about 1% wt/wt, preferably from about 0.01% wt/wt to about 0.5% wt/wt, of the composition.

In step 3, the mixture may be treated with a non-oxidizing gas prior to the freezing stage in order to displace the air, and particularly the gaseous oxygen therein to prevent oxidation of the food product. This step may be performed in pressure chamber 104 with the mixture of the puree, plant extract, and/or emulsifier placed in the pressure chamber 104, and nitrogen gas may be pumped into the pressurized chamber 104, thereby displacing the air (including O₂). The displaced air may be released from the pressurized chamber via a valve. A sufficient amount of N₂ gas may be pumped into the chamber 104 to infuse the puree and displace substantially all of the air in the puree (e.g., in a range of about 80% to about 99% of the air volume present in the puree). The blender chamber may include a hose attachment for passing N₂ gas pumped from a reservoir 105. The chamber 104 may also include a one-way valve to allow the air to be vented from the blender chamber.

In step 4, the pureed mixture may be molded into pre-determined shapes. The puree may be molded into a geometric body of a regular shape, for example, in particular, spherical caps, spheroidal caps, rectangular prisms, pyramids, as well as irregular shapes and whimsical shapes, such as those in the form of animals, plants and parts of plants, such as leaves etc. by a mold structure 106. In step 5, the mold structure may then be placed in a thermal treatment unit 107, which may be a conventional freezer, a blast freezer, or other thermal treatment unit. The rate at which a material is frozen during the thermal processing is dependent on the type of material. Higher water content of pureed fruits and vegetables correlates with a higher freezing rate. Fruits and vegetable purees may have a moisture content in a range of about 80% wt/wt to about 95% wt/wt. Such materials may be best frozen at a relative low temperature in order to yield a higher number of small ice crystals, which facilitates sublimation of the ice during the drying process. The freezing temperature for such fruit and vegetable purees may be in the range of about −50° C. to about −20° C. (or any value or range of values therein).

In step 6, the thermally processed mixture may undergo a primary freeze-drying process, in which the ice sublimation occurs. The thermally-processed, molded mixture may be placed in a freeze-drying apparatus 108 (a more detailed depiction of a freeze-drying apparatus is provided in FIG. 2). The thermally-processed, molded mixture may be placed on shelves 108a, from which heat may be transferred from the shelf to the surface of the frozen composition and heating the frozen water. Heating elements 108b may warm the shelf, which may then transfer the thermal energy to the mixture thereon. The pressure, vapor pressure, and applied heat parameters during the freeze-drying process are pre-determined to accomplish successful freeze-drying. The supplied heat may be fluctuated depending on the heating method: for contact heating using a heating shelf arrangement, the shelf temperature determines heat transfer. The temperature of the condenser surface should be from about 10° C. to about 20° C., depending on the type of freeze-dried material. The pressure within the chamber may be in a range of about 0.001 atm to about 0.01 atm. Sublimed steam may be removed from the freeze-drying chamber by applied vacuum. The vapor extracted from the food product may be removed from the drying chamber by means of condenser plates or coils of condenser chamber wherein the vapor can be re-solidified or frozen.

In step 7, a secondary drying step (a post-drying step) may be conducted under a reduced pressure to remove unfrozen water and/or other liquids that cannot be removed by sublimation. This step may be performed to remove the water present in the freeze-dried material that did not form ice during the freezing process, and instead is bound to the solid material (matrix) of the freeze-dried substance. During the second drying step, the freeze-dried food product may go through a second freeze-drying process in the freeze-drying apparatus 108 to desorb absorbed water (water attached to the dry material that did no freeze) by evaporation and desorption of the formed steam from the solid matrix of the freeze-dried product, convective transport through pores in the material, gas diffusion of the steam, and diffusion of water out of the matrix and dry material. During this phase the shelf temperature is further increased up to a maximum of about 20° C. to about 40° C. to heat the product, while the pressure inside the drying chamber is lowered to below about 0.0001 atm to about 0.001 atm. At the end of secondary drying phase, the product may be sufficiently dried with residual moisture content typically of about 1% to about 3% wt/wt.

In some embodiments, the methods of the present invention may include additional steps to create a compressed-form confection from the freeze-dried food product. As shown in FIG. 1B, the method of the present invention may include the additional steps 8 and 9: powderizing the freeze-dried product and pressing the powderized food product into a compressed form. The powderization and compression may provide uniform texture and/or to allow for quick dissolution of the freeze-dried food product when ingested. In step 8, the freeze-dried food product 110 can be powderized using a grinder or mill 150 to break down the food product 110 into a fine powder. In some embodiments, this may be performed in a low-oxygen environment, under N₂ gas provided by a reservoir 155 to prevent the additional of oxygen species into the freeze-dried material. The powderized food product may have a particle diameter of about 50 μm to about 250 μm (e.g., about 100 μm to about 200 μm, or any range or value therein).

In step 9, the powderized food product may then be placed into a mechanical press 160 to form compact bite-sized snack/candies 115 of uniform size and density to allow for the product to be easily packaged into various packaging types, including small pouches, candy trays and tins, plastic tubes, candy and roll packaging. The press 160 may form a bite-sized snack or candy 115 by pressing action of two sets of punches (upper punches 161 and lower punches 162) and a die 165. In a first step, a lower punch 162 may be raised into a cavity in the die 165 creating a cavity into which the powderized food product is fed through the feeding delivery system 164. The depth of the lower punch 162 may be set to apply a pre-determined size and volume of the snack or candy 115. An upper punch 161 may be brought into contact with the powder and compress the powderized food product to fuse the powderized food product together into a hard snack or candy 115. After compression, the lower punch 162 may be raised to remove the snack or candy 115. The upper punches 161 may be on a track, belt, or chain 161a and may be inferiorly actuated by compression rollers 166a and 166b. The lower punches 162 may be on a track, belt, or chain 162a and may be inferiorly actuated by compression rollers 167a and 167b. The pressing process may provide a consistently sized and shaped confection product.

The freeze dryer apparatus 200 may have a drying chamber 201, an external condenser 202, and a vacuum pump system 203 for reducing pressure in the chamber. The vacuum pump system may be operable to reduce the pressure in the drying chamber 201 during the primary and secondary freeze-drying processes (e.g., to a pressure of about 0.0001 atm or greater). Sublimation begins at the outer surface of the specimen and recedes towards the center of the specimen as drying advances. The sublimation of frozen water and/or other liquids creates dried regions with porous structure, comprising a network of pores and gaps for the vapor escape. As ice molecules change to a vapor state, they are carried away from the specimen by lower pressure in the drying chamber. The condenser 201 collects the moisture removed from the food product mixture warmed to a relatively higher temperature by the radiant heat sources 108b and the shelves 108a in the low-pressure freeze-drying environment. The refrigerated condenser has a lower local temperature and presents substantially lower vapor pressure than in the drying chamber, which causes a migration of the vapor from the drying chamber to the condenser 202 region.

### CONCLUSION/SUMMARY

The present invention provides novel freeze-dried food products (e.g., confections) and methods of making the same. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A method of providing a preserved food product with no added preservative chemicals comprising the steps of:
a. providing a pureed food ingredient free from preservative chemicals;
b. admixing a non-oxidizing gas with the pureed food ingredient;
c. thermally processing the pureed food ingredient; and
d. freeze drying the food ingredient.

2. The method of claim 1 wherein the food ingredient is present in an amount of greater than 95% wt/wt of the product.

3. The method of claim 1, wherein the food product comprises at least one fresh fruit or vegetable.

4. The method of claim 1, wherein the food product includes a baked food mixture free from preservative chemicals.

5. The method of claim 1, wherein the non-oxidizing gas comprises nitrogen gas.

6. The method of claim 1, wherein the pureed food ingredient is shaped into a pre-determined shape.

7. The method of claim 6, wherein the pureed food ingredient is poured in to a mold prior to the step of thermally processing the blend.

8. The method of claim 6, wherein the pre-determined shape has a volume of less than about five cubic inches.

9. The method of claim 1, further comprising mixing plant extract into said pureed food ingredient, wherein said emulsifier is added into said pureed food ingredient at a concentration of 0.01% wt/wt to about 5% wt/wt of the pureed food ingredient.

10. The method of claim 9, further comprising mixing at least one emulsifier into said pureed food ingredient, wherein said emulsifier is added into said pureed food ingredient at a concentration of 0.001% wt/wt to about 1% wt/wt of the pureed food ingredient.

11. The method of claim 1, further comprising displacing air from said pureed food ingredient.

12. The method of claim 1, further comprising displacing O₂ from said pureed food ingredient.

13. The method of claim 1, further comprising pouring said pureed food ingredient into a mold having a volume of less than about 4 cubic inches.

14. The method of claim 1, further comprising pulverizing the freeze-dried pureed food ingredient.

15. The method of claim 14, further comprising said freeze-dried food ingredient into a mold having a volume of less than about 1 cubic inch.

16. A shelf stable freeze-dried food product comprising at least 90% wt/wt fresh fruit or vegetable ingredient that is free from preservative chemicals and that comprises is substantially water-free and oxygen-free.

17. The product of claim 16, wherein the food ingredient is present in an amount of greater than 95% wt/wt of the product.

18. The product of claim 16, further comprising a non-oxidizing gas.

19. The product of claim 16, wherein the non-oxidizing gas is nitrogen gas.

20. The product of claim 16, wherein the pureed food ingredient is shaped into a pre-determined shape.

21. The product of claim 20, wherein the fresh fruit is pureed food ingredient is pureed and poured in to a mold to form said pre-determined shape.

22. The product of claim 16, wherein the pre-determined shape has a volume of less than about five cubic inches.

23. The product of claim 16, further comprising mixing plant extract into said pureed food ingredient, wherein said emulsifier is added into said pureed food ingredient at a concentration of 0.01% wt/wt to about 5% wt/wt of the pureed food ingredient.

24. The product of claim 16, further comprising mixing at least one emulsifier into said pureed food ingredient, wherein said emulsifier is added into said pureed food ingredient at a concentration of 0.001% wt/wt to about 1% wt/wt of the pureed food ingredient.

25. The product of claim 20, wherein said pre-determined shape is formed by pulverizing a freeze-dried food ingredient into a fine powder, and placed in a press.

26. The product of claim 25, wherein said pre-determined shape has a volume of less than about 1 cubic inch.

27. A shelf stable freeze-dried food product comprising a food product free from preservative chemicals and that comprises is substantially water-free and oxygen-free.

28. The product of claim 27, wherein the food ingredient is present in an amount of greater than 95% wt/wt of the product.

29. The product of claim 28, wherein the food ingredient comprises at least one fresh fruit or vegetable.

30. The product of claim 28, wherein the food ingredient consists of at least one type of fresh fruit or vegetable.

31. The product of claim 28, wherein the food ingredient includes a baked food mixture free from preservative chemicals.

32. The product of claim 27, further comprising a non-oxidizing gas.

33. The product of claim 27, wherein the non-oxidizing gas is nitrogen gas.

34. The product of claim 27, wherein the pureed food ingredient is shaped into a pre-determined shape.

35. The product of claim 34, wherein the fresh fruit is pureed food ingredient is pureed and poured in to a mold to form said pre-determined shape.

36. The product of claim 27, wherein the pre-determined shape has a volume of less than about five cubic inches.

37. The product of claim 27, further comprising an emulsifier.

38. The product of claim 37, wherein said emulsifier is present in a concentration of 0.001% wt/wt to about 1% wt/wt of the freeze-dried product.

39. The product of claim 34, wherein said pre-determined shape is formed by pulverizing a freeze-dried food ingredient into a fine powder, and placed in a press.

40. The product of claim 27, wherein said pre-determined shape has a volume of less than about 1 cubic inch.

41. A freeze-dried product comprising a blend selected from the group consisting of fruit, vegetable, dairy, protein, grain and combinations thereof in an amount of greater than about 95% of the freeze-dried product, said freeze-dried product being substantially free from water and oxygen gas.

42. The product of claim 41, wherein the blend is present in an amount of greater than 95% wt/wt of the product.

43. The product of claim 42, wherein the food ingredient comprises at least one fresh fruit or vegetable.

44. The product of claim 42, wherein the food ingredient consists of at least one type of fresh fruit or vegetable.

45. The product of claim 42, wherein the food ingredient includes a baked food mixture free from preservative chemicals.

46. The product of claim 41, further comprising a non-oxidizing gas.

47. The product of claim 41, wherein the non-oxidizing gas is nitrogen gas.

48. The product of claim 41, wherein the pureed food ingredient is shaped into a pre-determined shape.

49. The product of claim 48, wherein the fresh fruit is pureed food ingredient is pureed and poured in to a mold to form said pre-determined shape.

50. The product of claim 41, wherein the pre-determined shape has a volume of less than about five cubic inches.

51. The product of claim 41, further comprising mixing plant extract into said pureed food ingredient, wherein said emulsifier is added into said pureed food ingredient at a concentration of 0.01% wt/wt to about 5% wt/wt of the pureed food ingredient.

52. The product of claim 41, further comprising mixing at least one emulsifier into said pureed food ingredient, wherein said emulsifier is added into said pureed food ingredient at a concentration of 0.001% wt/wt to about 1% wt/wt of the pureed food ingredient.

53. The product of claim 48, wherein said pre-determined shape is formed by pulverizing a freeze-dried food ingredient into a fine powder, and placed in a press.

54. The product of claim 41, wherein said pre-determined shape has a volume of less than about ¼ cubic inches.

55. A method of providing a preserved food product with no added preservative chemicals comprising the steps of:
a. creating a blended food product comprising greater than 95% wt/wt of a pureed food ingredient free from preservative chemicals;
b. admixing a non-oxidizing gas with the pureed food ingredient to displace O₂ from the blended food product;
c. placing the blended food product in a mold having a pre-determined shape;
d. thermally processing the pureed food ingredient; and
e. freeze drying the food ingredient.

56. The method of claim 55, wherein the pureed food product comprises at least one fresh fruit or vegetable.

57. The method of claim 55, wherein the pureed food product includes a baked food mixture free from preservative chemicals.

58. The method of claim 55, wherein the non-oxidizing gas comprises nitrogen gas.

59. The method of claim 55, wherein the pre-determined shape has a volume of less than about five cubic inches.

60. The method of claim 55, further comprising mixing plant extract into said pureed food ingredient, wherein said emulsifier is added into said pureed food ingredient at a concentration of 0.01% wt/wt to about 5% wt/wt of the pureed food ingredient.

61. The method of claim 55, further comprising mixing at least one emulsifier into said pureed food ingredient, wherein said emulsifier is added into said pureed food ingredient at a concentration of 0.001% wt/wt to about 1% wt/wt of the pureed food ingredient.

62. The method of claim 55, further comprising pulverizing the freeze-dried pureed food ingredient.

63. The method of claim 62, further comprising said freeze-dried food ingredient into a mold having a volume of less than about 1 cubic inch.
